(19) United States
(12) Patent Application Publication
(10) Pub. No.: US 2009/0236978 A1
(43) Pub. Date: Sep. 24, 2009

(54) WHITE ELECTROLUMINESCENT ORGANIC DIODES BASED ON MOLECULES DERIVED FROM PHOSPHOLE

(75) Inventors: Noella Lemaitre, Chambery (FR); Bernard Geffroy, L'Hay Les Roses (FR); Omrane Fadhel, Saint Carne (FR); Muriel Hissler, Chantepie (FR); Regis Reau, Chapelle Des Fougerez (FR)

Correspondence Address: OBLON, SPIVAK, MCCLELLAND MAIER & NEUSTADT, P.C., 1940 DUKE STREET, ALEXANDRIA, VA, 22314, US

(73) Assignees: COMMISSARIAT A L'ENERGIE ATOMIQUE, PARIS (FR); UNIVERSITE DE RENNES 1, RENNES (FR)

(21) Appl. No.: 12/374,881

(22) PCT Filed: Jul. 24, 2007
(86) PCT No.: PCT/EP07/57604

§ 371 Date: Jan. 23, 2009

(30) Foreign Application Priority Data
Jul. 27, 2006 (FR) 06 53146

(51) Int. Cl. H01J 1/63

(52) U.S. Cl. 313/504

(57) ABSTRACT

The invention concerns a white electroluminescent organic diode, providing, under the effect of electrical polarization, a white light composed of a mixture of at least one first colour and a second colour emitted respectively by a first phosphorous material and by a second phosphorous material. At least one of these phosphorous materials is a phosphole-based material, said material being of the fluorescent type or phosphorescent type

### TECHNICAL FIELD

The invention relates to white electroluminescent organic diodes in which the emitted light stems from a mixture of colours supplied by at least two phosphorous materials.

### STATE OF THE PRIOR ART

Electroluminescence is a phenomenon by which an electrical excitation gives rise to the emission of an electromagnetic radiation. An organic electroluminescent diode functions through creation of excitons. To create excitons, a layer of phosphorous material is placed in a sandwich between a cathode electrode and an anode electrode. Electrons are injected from the cathode whereas holes are injected from the anode. The electrons and the holes move about in the phosphorous material and meet to form excitons, which are excited and linked electron-hole pairs. When the electron and the hole of an exciton combine, a photon may be emitted.

There has been increasing interest in electroluminescent organic diodes over recent years on account of their low operating voltage, their high luminance, their large angle of view and their ability to lead to flat colour devices. Thanks to these properties, the initial applications envisaged for these diodes, still known as OLED (organic light-emitting diode), were monochromic then colour display devices.

The display range is no longer only in consideration. Indeed white OLED or WOLED (White OLED) are good candidates for the next generation of light sources, replacing incandescent lamps, thanks to their high energy saving potential, their high efficiency and their possibility of leading to thin and flexible devices. White OLEDs are thus now envisaged as low cost light sources for producing back lighting of LCD devices, for domestic lighting, etc. For all these applications, the white OLED employed must have a high efficiency and a high luminosity, as well as chromatic coordinates close to those of D65, the standard illuminant of the CIE (International Commission on Illumination) (see document [1] cited at the end of the description), which are (0.313-0.329) under daylight.

The width of the emission spectrum of the chromophores conventionally used in the OLED represents around one third of the visible spectrum, an efficient white emission and which is very difficult to obtain from a single molecule. However, a white light composite may be obtained by mixing the three primary colours (blue, green and red) or two complementary colours in the right proportions within a same diode. Documents [2] and [3] may be referred to in this respect.

Obtaining white light by emission of three colours blue (B), green (G) and red (R) has been described in the prior art. For instance, document US 2003/099860 discloses the combination of a blue emission stemming from 4,4′-bis(2,2-diphenylvinyl) biphenyl or DPVBi with red and green emissions stemming respectively from [2-methyl-6-[2-(2,3,6,7-tetrahydro-1H,5H-benzo[ij]quinolizin-9-yl)ethenyl]-4H-pyranne-4-ylidene]propane-dinitrite or DCM2 and coumarin 6. In this case, the white diode is constituted of different emitting layers R, G, B as well as transport layers in a multilayer structure. Another approach may also be employed in which the blue, green and red emitters are pixelised within a device as disclosed in document US 2003/197 665.

The use of two chromophores emitting complementary colours to produce white electroluminescent organic diodes has already been disclosed in documents US 2004/0 241 491, US 2004/185 300 and EP-A-1 381 096. These documents used the combination of a blue emitting layer with a rubrene or perylene derivative as orangey yellow emitter so as to produce white light. Orangey yellow emitters may be used as dopants of the blue emitting layer or a transport layer, as well as in continuous emitting layer.

Moreover, phosphole derivatives have been tested as emitter or array of a red dopant, 4-(dicyanomethylene)-2-t-butyl-6(1,1,7,7-tetramethyljulolidyl-9-enyl)-4H-pyranne or DCJTB, in a multilayer structure between two electrodes (see documents [4] and [5]). Document JP 2003-231741 A (corresponding to document US 2005/042 195) discloses the synthesis and the characterisation of polymers containing a benzophosphole fragment. These polymers are described as potentially interesting as emitting compounds in OLED.

### DESCRIPTION OF THE INVENTION

The present invention proposes using materials (polymers or molecules) derived from phosphole to produce white electroluminescent organic diodes. The molecular engineering that can be carried out on this family of compounds makes it possible to obtain efficient fluorescent and phosphorescent molecules, as well as the modulation of their emission wavelength. This modulation makes it possible to adjust the emission colour of the molecules and thereby to obtain a white light of good quality.

The subject of the invention is thus a white electroluminescent organic diode, providing, under the effect of an electrical polarization, a white light composed of a mixture of at least one first colour and a second colour emitted respectively by a first phosphorous material and by a second phosphorous material, characterised in that at least one of these phosphorous materials is a phosphole-based material, said material being of fluorescent type or phosphorescent type.

### BRIEF DESCRIPTION OF DRAWINGS

The present invention will be better understood and other advantages and particularities will become clear on reading the description that follows, given purely by way of indication and in no way limiting, and by referring to the appended figures in which:

FIG. 1 is a schematic and transversal sectional view of a white electroluminescent diode according to the invention,

FIG. 2 is a representation of the chromatic coordinates of diodes using phosphole derivatives and showing the influence of these derivatives,

FIG. 3 represents the electroluminescence spectra of diodes using phosphole derivatives,

FIG. 4 is a representation of the chromatic coordinates of diodes using phosphole derivatives and showing the influence of these derivatives,

FIG. 5 represents the electroluminescence spectra of diodes using phosphole derivatives,

FIG. 6 is a representation of the chromatic coordinates of diodes using phosphole derivatives and showing the influence of these derivatives.

### DETAILED DESCRIPTION OF SPECIFIC EMBODIMENTS

According to the present invention, white electroluminescent organic diodes are produced using a family of molecules derived from phosphole and present in diodes in the form of a polymer-based material incorporating the phosphole structures in the principal chain or in the pendant chain, or directly based on small molecules.

These molecules may be fluorescent or phosphorescent and be used as dopants of an emitting layer or a transport layer, as well as emitting monolayer.

A fluorescent molecule derived from phosphole may be represented as follows:

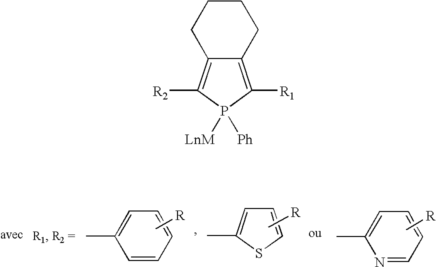

R=alkyl, alkoxy, aryloxy, alkylthio, arylthio, a polar group (—SO₃H, ammonium groups, etc.)

MLn=AuCl, W(CO)₅, ═S, ═0

A phosphorescent molecule derived from phosphole may be represented as follows:

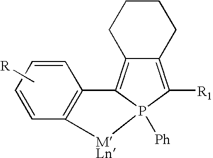

where M′Ln′=PtX(pyridine), Ir(bipyridine)Cl₂, etc.

The molecular engineering that may be developed around this family of compounds by chemical modification of the reactive phosphorous atom or the nature of the substituents or the nature of the ligands and the metallic centre when it is an organometallic complex, makes it possible to modify the absorption and emission wavelengths of the molecules. It is thereby possible to modulate the emission of these molecules and to adjust them so as to obtain either three primary colours or two complementary colours and thereby obtain a white of good optical quality.

In the case where polymers integrating phosphole structures are used, their preparation may take place in accordance with the teaching of document [6].

The production of WOLED multilayers based on oligomers containing a phosphole ring takes place by vacuum thermal evaporation. The phosphole may be deposited as thin emitting layer or as dopant of an emissive array or a transport layer. In the case of a polymer, the deposition may take place by wet process (spin coating, etc.). The phosphole derivatives used are chosen as a function of the colour of the desired emitters and their optical properties may be adjusted by chemical modification.

The modulation of the proportions of the emission of the three primary colours or two complementary colours must then be made by varying the doping percentages in the case of a doped system, or by varying the thickness and the position of the phosphole monolayers. This makes it possible to obtain a white composite emission colour.

Efficient white diodes with chromatic coordinates close to D65 (0.313-0.329) are thereby formed, by doping a blue emissive array by a phosphole derivative.

The following examples illustrate the production of WOLED according to the invention and have the characteristics of said WOLED.

All of the diodes disclosed are obtained by vacuum thermal evaporation (<10⁻⁶ Torr) of small organic molecules on glass—ITO substrates at deposition rates of around 0.2 to 0.3 nm/s. The doped layers are formed by thermal co-evaporation of the array and the dopant. The organic materials used are commercially available with the exception of phosphole derivatives, materials synthesised within the scope of the invention. Hole injection (CuPc) and hole transport (NPB) and electron transport (Alq₃) layers are used for producing the diodes described in the example.

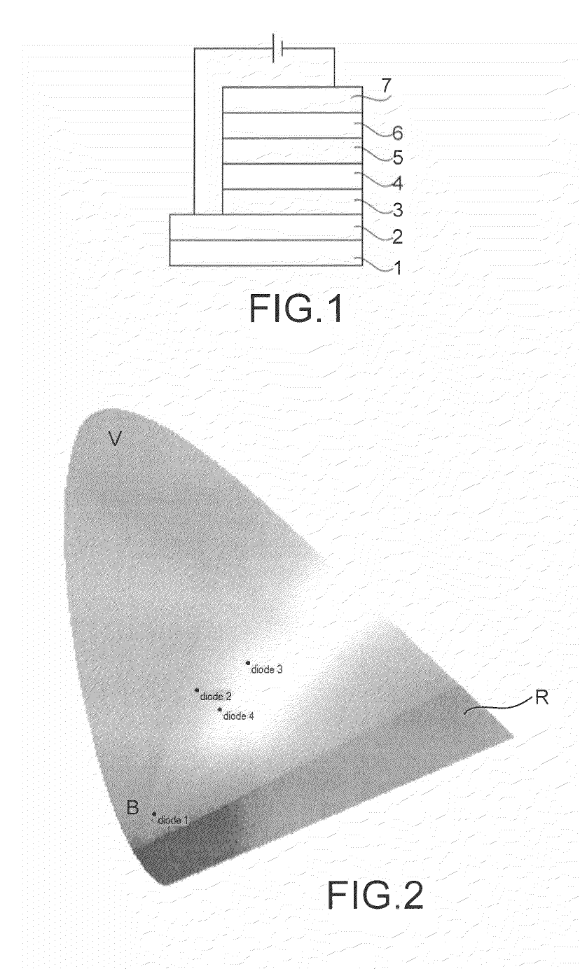

FIG. 1 is a schematic and sectional view of a white electroluminescent diode according to the invention. It is constituted of a stacking comprising a transparent substrate made of glass 1, a transparent electrode 2 serving as anode, a hole injection layer 3, a hole transport layer 4, a light emitting layer 5, an electron transport layer 6 and an electrode 7 serving as cathode. The transparent electrode 2 is for example a layer of ITO (mixed oxide of tin and indium) of 100 to 200 nm thickness. The hole injection layer 3 may be made of copper phthalocyanine (or CuPc) and have a thickness of 10 nm. The hole transport layer 4 may be made of N,N′-bis-(1-naphthyl)-N,N′-diphenyl-1.1° biphenyl 1-4-4′-diamine or (NPB) and have a thickness of 50 nm. The light emitting layer 5 may be a layer of DPVBi (forming a blue array) doped by a phosphole derivative, according to the invention. Its thickness may be 50 nm. The electron transport layer 6 may be a layer of tris(8-hydroxyquinoline)aluminium (or Alq₃) and have a thickness of 10 nm. The cathode 7 may be formed of a layer of 1.2 nm thickness of lithium fluoride and a layer of 100 nm thickness of aluminium deposited successively on the layer 6.

The current-voltage-luminance (I-V-L) characteristics as well as the electroluminescence spectra of the diodes are recorded under air at ambient temperature, without encapsulation of the devices. The chromatic coordinates (x; y) of the International Commission on Illumination (CIE) of the diodes are given according to the 1931 convention.

### First Embodiment Example

The following two fluorescent molecules have been used at different doping percentages in the blue DPVBi array of the diode described above and represented in FIG. 1.

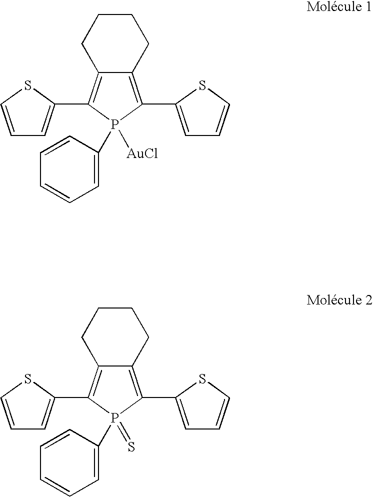

Table 1 gives the performances and the chromatic coordinates of the different diodes produced. Diode 1 is a blue reference diode in which the DPVBi array has not been doped. Its chromatic coordinates are (0.155; 0.130) and its quantum efficiency is 3.6%. The doping is given in % by weight of the dopant compared to the array. λₑₘmax is the wavelength of the emission maximum.

TABLE 1

| | λₑₘ max | Efficiency | | | CIE | | |
|---|---|---|---|---|---|---|---|
| Diode | (nm) | % | cd/A | Im/W | x | y | Colour |
| 1/DPVBi | 452 | 3.6 | 4.0 | 1.2 | 0.155 | 0.130 | Blue |
| 2/DPVBi: | 476/500 | 2.4 | 5.8 | 1.9 | 0.222 | 0.344 | Green-blue |
| molecule 1 | | | | | | | |
| (0.4%) | | | | | | | |
| 3/DPVBi: | 444/548 | 2.7 | 7.0 | 2.3 | 0.305 | 0.391 | White-green |
| molecule 2 | | | | | | | |
| (0.2%) | | | | | | | |
| 4/DPVBi: | 444/548 | 2.7 | 6.1 | 2.0 | 0.260 | 0.310 | White |
| molecule 2 | | | | | | | |
| (0.1%) | | | | | | | |

The diode 2 formed has chromatic coordinates of (0.222; 0.344). The emission colour of this diode is thus green-blue as shown in FIG. 2, which is a representation of the chromatic coordinates of diodes 1 to 4 in the CIE diagram of 1931. In this diagram, the red (R), green (G) and blue (B) zones have been indicated. The replacement of the AuCl substituent of the P atom by a sulphur atom (molecule 2) makes it possible to shift the emission of the dopant from 500 to 548 nm and thereby to obtain white diodes.

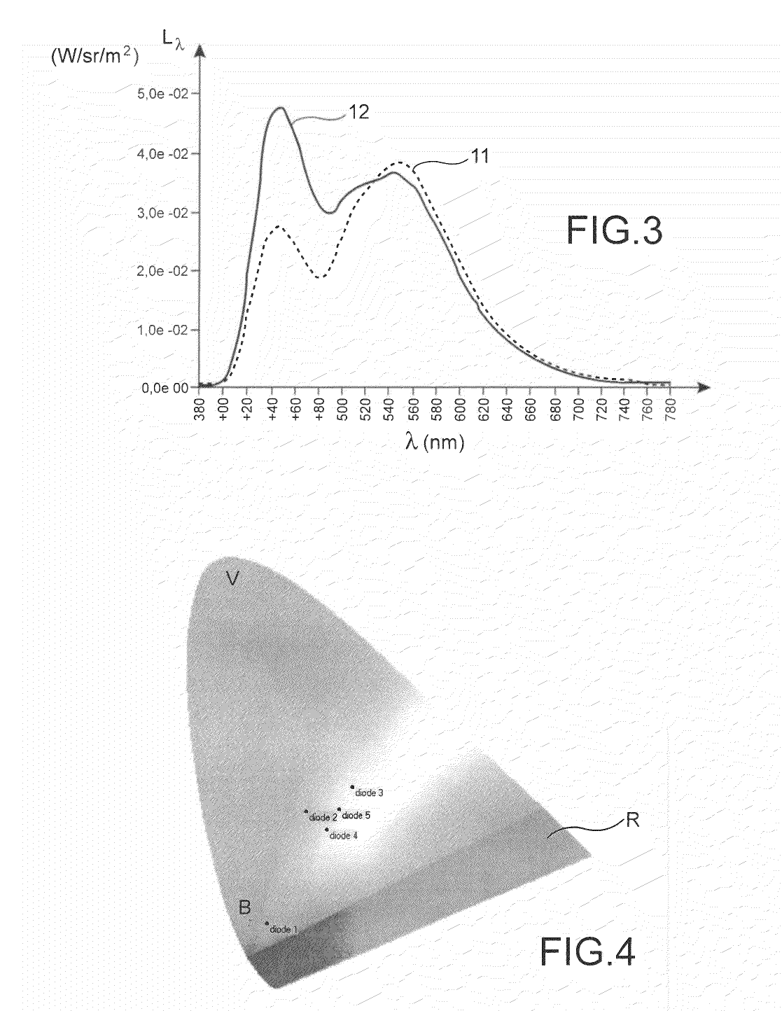

FIG. 3 represents the electroluminescence spectra of diodes 3 and 4. The Y-axis represents the spectral luminance L_{λ} in watts per steradian and per m². The X-axis represents the wavelength λ. Curve 11 has been drawn for diode 3 and curve 12 has been drawn for diode 4.

The modulation of the respective emissions of the array and the dopant (see FIG. 3) by playing on the doping percentage makes it possible to adjust the chromatic coordinates of the diodes to obtain a white of good optical quality. Thus, by reducing the doping percentage of diode 3 from 0.2% to 0.1% to obtain diode 4, the chromatic coordinates of the diodes go from (0.305; 0.391) to (0.260; 0.310) i.e. from a slightly green white to a white of better optical quality.

### Second Embodiment Example

The molecules of example 1 may also be used as dopant of a transport layer of the diode described above, for example the hole transport layer. For this diode, the hole transport layer is made of NPB. Table 2 gives the performances and the chromatic coordinates of diode 5 produced by doping the NPB by molecule 2 at a rate of 0.25% by weight.

TABLE 2

| | λₑₘ max | Efficiency | | | CIE | | |
|---|---|---|---|---|---|---|---|
| Diode | (nm) | % | cd/A | Im/W | x | y | Colour |
| 5/NPB: | 448/548 | 2.8 | 6.8 | 2.3 | 0.281 | 0.348 | White |
| molecule 2 | | | | | | | |
| (0.25%) | | | | | | | |

FIG. 4 is a representation of the chromatic coordinates of diodes 1 to 5 in the CIE diagram of 1931.

The doping of the transport layer instead of the blue array by molecule 2 may also lead to a white diode, as proven by diode 5, the chromatic coordinates of which are (0.281; 0.348). The alignment of the coordinates (x; y) of diodes 1, 3, 4 and 5 on a same line shows that the emission of the dopant is similar whether it is in the NPB or the DPVBi (see FIG. 4). The colour of the diode is a composite colour of two constituents: blue stemming from the DPVBi (diode 1) and orangey yellow stemming from the dopant (molecule 2). The quantum efficiency of the diode 5 is 2.8%, a similar output to that of diodes 3 and 4.

This proves that the doping may be carried out in the blue array but also in the transport layer.

### Third Embodiment Example

In this embodiment example, the dopant used in the hole transport layer is molecule 3 which, compared to molecule 2, has methyl groups in position 4 on the thiophene rings.

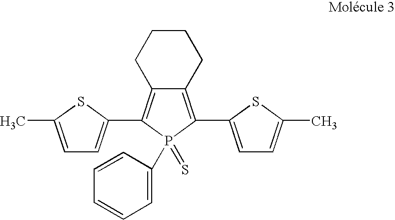

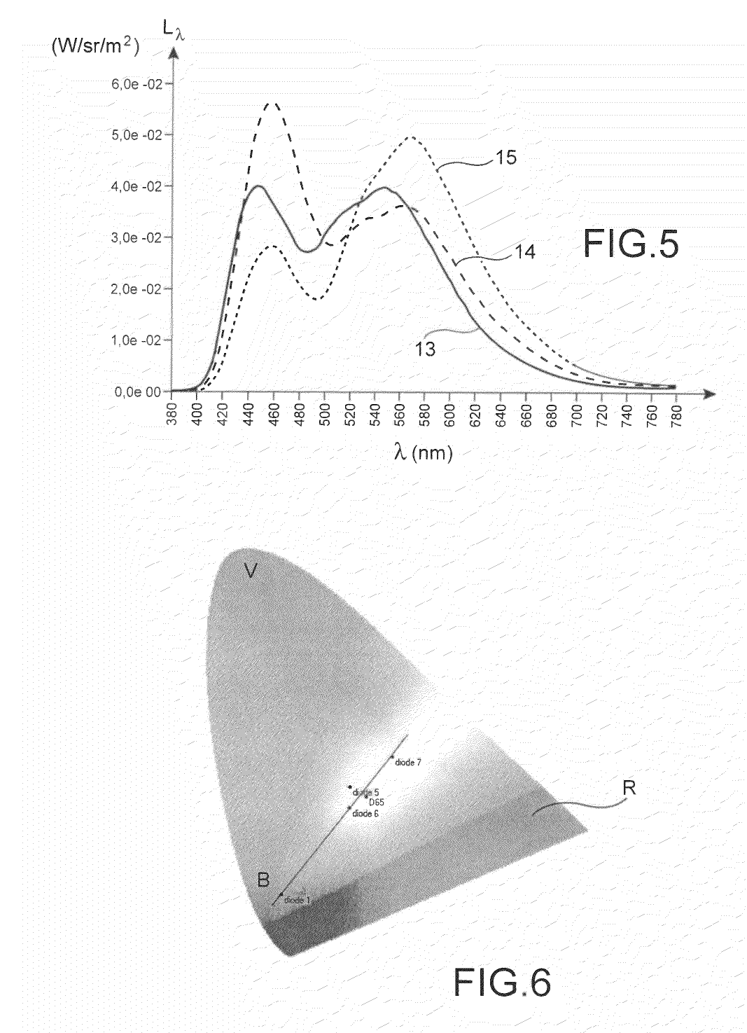

This substitution of the thiophene rings of molecule 3 by a slightly donor methyl group makes it possible to obtain a slight red shift of the emission of the dopant, as shown by the electroluminescence spectra of diodes 6 and 7, in comparison to that of diode 5. FIG. 5 represents the electroluminescence spectra of diodes 5 (curve 13), 6 (curve 14) and 7 (curve 15).

Moreover, diodes having very good quantum efficiencies ensue from this, from 3.6 to 3.9% for doping percentages by weight in the NPB of 0.2% and 0.4% respectively, as shown in table 3.

TABLE 3

| | λₑₘ max | Efficiency | | | CIE | | |
|---|---|---|---|---|---|---|---|
| Diode | (nm) | % | cd/A | Im/W | x | y | Colour |
| 6/NPB: | 456/564 | 3.6 | 7.8 | 2.0 | 0.282 | 0.306 | White |
| molecule 3 | | | | | | | |
| (0.20%) | | | | | | | |
| 7/NPB: | 456/568 | 3.9 | 10.0 | 2.6 | 0.362 | 0.411 | White-yellow |
| molecule 3 | | | | | | | |
| (0.40%) | | | | | | | |

The emission of diode 6 is white. As for that of diode 7, it is white-yellow as shown by their chromatic coordinates indicated in FIG. 6.

The red shift of the emission of molecule 3 by substitution of its lateral thiophene groups has thereby made it possible to obtain efficient white diodes with chromatic coordinates closer to those of D65, the standard reference CIE illuminant under daylight, which are (0.313; 0.329).

In the examples described above, the phosphole derivatives are preferentially used as complement of a blue emitter.

### REFERENCES

[1] “White Organic Light-Emitting Devices for Solid-State Lighting”, B. W. D'Andrade et al., Adv. Mater. 2004, 16, No. 18, •1585-1595.
[2] “Blue and white emitting organic diodes based on anthracene derivative”, Z. L. Zhang et al., Synthetic Metals 137 (2003), pages 1141-1142.
[3] “Highly-bright white organic light-emitting diodes based on a single emission layer”, C. H. Chuen et al., Appl. Phys. Lett., Vol. 81, No. 24, 9 Dec. 2002, pages 4499 to 4501.
[4] “First Examples of Organophosphorus-Containing Materials for Light-Emitting Diodes”, C. Fave et al., J. Am. Chem. Soc., 2003, 125, pages 9254-9255.
[5] “Toward functional pi-conjugated organophosphorus materials: design of phosphole-based oligomers for electroluminescent devices”, H. C. Su et al., J. Am. Chem. Soc., 2006, 128(3), pages 983 to 995.
[6] “Synthesis and Properties of First Well-Defined Phosphole-Containing π-Conjugated Polymers”, Y. Morisaki et al., Macromolecules 2003, 36, 2594-2597.

1. White electroluminescent organic diode, providing, under the effect of an electrical polarization, a white light composed of a mixture of at least one first colour and a second colour emitted respectively by a first phosphorous material and by a second phosphorous material, characterised in that at least one of these phosphorous materials is a phosphole-based material, said material being of fluorescent type or phosphorescent type.

2. White electroluminescent organic diode according to claim 1, characterised in that the phosphole-based fluorescent type material has the following chemical structure: 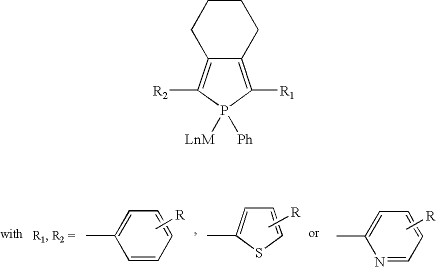
R=alkyl, alkoxy, aryloxy, alkylthio, arylthio, or a polar group
MLn=AuCl, W(CO)₅, ═S, =0.

3. White electroluminescent organic diode according to claim 1, characterised in that the phosphole-based phosphorescent type material has the following chemical structure: 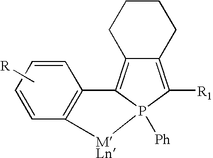
where M′Ln′=PtX(pyridine) or Ir(bipyridine)Cl₂.

4. White electroluminescent organic diode according to claim 1, characterised in that the phosphole-based material is present in the form of layer in the diode.

5. White electroluminescent organic diode according to claim 1, characterised in that the phosphole-based material is present as dopant of an emissive array constituted of the other phosphorous material.

6. White electroluminescent organic diode according to claim 1, characterised in that the phosphole-based material is present as dopant of an electron transport layer or a hole transport layer that comprises the diode.

7. White electroluminescent organic diode according to claim 5, characterised in that the phosphole-based material is: 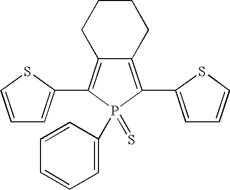
the emissive array being made of DPVBi.

8. White electroluminescent organic diode according to claim 6, characterised in that the phosphole-based material is: 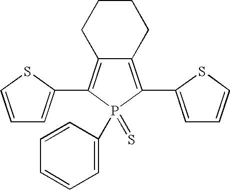
and is present as dopant of a hole transport layer made of NPB.

9. White electroluminescent organic diode according to claim 6, characterised in that the phosphole-based material is: 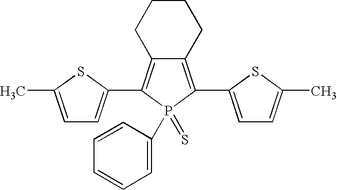
and is present as dopant of a hole transport layer made of NPB.
